(19) United States
(12) Patent Application Publication
(10) Pub. No.: US 2017/0075913 A1
(43) Pub. Date: Mar. 16, 2017

(54) INFORMATION PROCESSING APPARATUS, AND INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventors: Hiroshi OTA, Tokyo (JP); Honami HOSHINO, Tokyo (JP); Rie ANAI, Tokyo (JP)

(73) Assignee: YAHOO JAPAN CORPORATION, Tokyo (JP)

(21) Appl. No.: 15/232,332

(22) Filed: Aug. 9, 2016

(30) Foreign Application Priority Data
Sep. 15, 2015 (JP) 2015-181516

(51) Int. Cl. G06F 17/30; H04W 4/02; H04L 29/08

(52) U.S. Cl. CPC G06F 17/3089; H04L 67/22; H04L 67/32; H04W 4/023; G06F 17/30312; G06F 17/30604

(57) ABSTRACT

An information processing apparatus according to the embodiment includes a specifying unit, an acquisition unit, a determination unit, and a process unit. The specifying unit specifies two or more users that behave together. The acquisition unit acquires information on the two or more users specified by the specifying unit from a database that stores information on a plurality of users. The determination unit determines a relationship between the two or more users based on the information on the two or more users acquired by the acquisition unit. The process unit executes a process according to the relationship between the two or more users determined by the determination unit.

### CROSS-REFERENCE TO RELATED APPLICATION(S)

The present application claims priority to and incorporates by reference the entire contents of Japanese Patent Application No. 2015-181516 filed in Japan on Sep. 15, 2015.

### BACKGROUND OF THE INVENTION

1. Field of the Invention

The embodiment discussed herein is related to an information processing apparatus, an information processing method, and a non-transitory computer readable storage medium.

2. Description of the Related Art

In recent years, information provision using communication networks is popularly carried out along with the exponential spread of the communication networks. As a technology for the information provision, there is proposed a technology that provides information according to attributes of a group to which a plurality of persons belongs.

For example, there is proposed an apparatus that acquires attributes (genders and ages) of persons on the basis of an amount of characteristics of their face images that are captured by monitoring cameras or the like, determines attributes of the group, to which the persons belong, from attributes of each of them and the number of them, and provides information according to the determined group attributes (for example, see Patent Japanese Laid-open Patent Publication No. 2004-227158).

However, because the conventional apparatus determines the attributes of each person on the basis of an amount of characteristics of the corresponding person's face image, it is difficult to appropriately determine relationships between the persons, and thus processes according to relationships between users may not be executed appropriately.

### SUMMARY OF THE INVENTION

It is an object of the present invention to at least partially solve the problems in the conventional technology.

An information processing apparatus according to the embodiment includes a specifying unit, an acquisition unit, a determination unit, and a process unit. The specifying unit specifies two or more users that behave together. The acquisition unit acquires information on the two or more users specified by the specifying unit from a database that stores information on a plurality of users. The determination unit determines a relationship between the two or more users based on the information on the two or more users acquired by the acquisition unit. The process unit executes a process according to the relationship between the two or more users determined by the determination unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an information processing method according to an embodiment;

FIG. 2 is a diagram illustrating a configuration example of an information processing system according to the embodiment;

FIG. 3 is a diagram illustrating a configuration example of a wireless terminal;

FIG. 4 is a diagram illustrating a configuration example of an information processing apparatus;

FIG. 5 is a diagram illustrating an example of a user information table;

FIG. 6 is a diagram illustrating an example of a relationship type determination table;

FIG. 7 is a diagram illustrating an example of a familiarity degree determination table;

FIG. 8 is a diagram illustrating an example of a provision content determination table;

FIG. 9 is a diagram illustrating an example of contents that are provided from a provision unit and displayed on a display screen of the wireless terminal;

FIG. 10 is a flowchart illustrating an example of information processing in the information processing apparatus; and

FIG. 11 is a diagram illustrating a hardware configuration example of a computer that realizes functions of the information processing apparatus and the like.

### DETAILED DESCRIPTION OF THE PREFERRED EMBODIMENT

Hereinafter, an exemplary embodiment of an information processing apparatus, an information processing method, and a non-transitory computer readable storage medium according to the present application will be explained in detail with reference to the accompanying drawings. It is not intended that the information processing apparatus, the information processing method, and a non-transitory computer readable storage medium according to this application be limited to the embodiment described below.

1. Information Processing Method

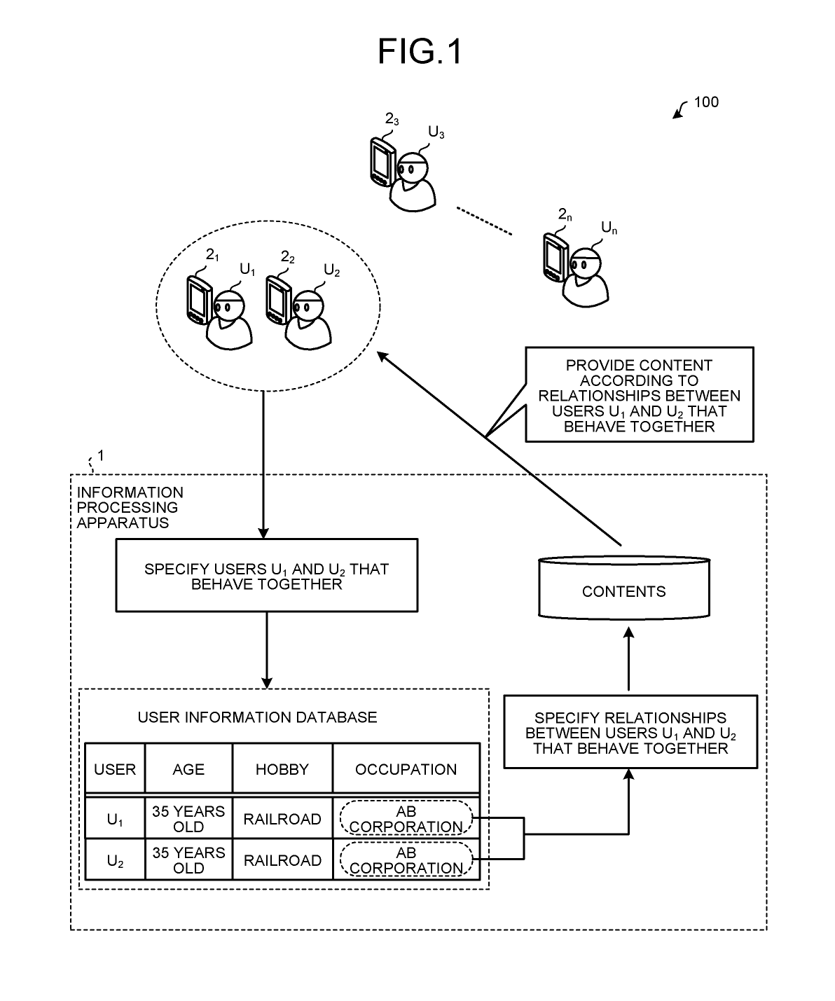

FIG. 1 is a diagram illustrating an example of an information processing method according to an embodiment. In the present embodiment, the information processing method is executed by an information processing apparatus 1 of an information processing system 100.

As illustrated in FIG. 1, the information processing system 100 includes, for example, the information processing apparatus 1 and wireless terminals 2₁ to 2ₙ that respective users U₁ to Uₙ have. Hereinafter, the users U₁ and U₂ are assumed to behave together.

The information processing apparatus 1 specifies the users U₁ and U₂ that behave together among users U₁ to Uₙ (hereinafter, may be collectively referred to as user(s) U). Whether the users behave together or not can be determined on the basis of, for example, information that is transmitted from the wireless terminals 2₁ to 2ₙ.

The wireless terminals 2₁ to 2ₙ (hereinafter, may be collectively referred to as wireless terminal(s) 2) include a wireless communication unit that performs Near Field Communication (NFC) such as Bluetooth (Registered Trademark). Also, for example, infrared communication, visible light communication, sonic waves, etc. can be used as the NFC.

The information processing apparatus 1 can specify the users U₁ and U₂ that behave together, on the basis of wireless signals that are received by the wireless terminals 2₁ to 2ₙ through the NFC. For example, when the wireless signals have been sent and received between the wireless terminals 2 for a predetermined time or more, the information processing apparatus 1 can specify the users U that have the two or more wireless terminals 2, which have sent or received the wireless signals for a predetermined time or more, as the users U that behave together.

Wireless communication devices that perform the NFC are provided at a plurality of spots, and the users U that behave together can be specified on the basis of reception states of the wireless terminals 2 that receive the wireless signals from the wireless communication devices. For example, the information processing apparatus 1 can specify, as the users U that behave together, the users U of the two or more wireless terminals 2 that receive the wireless signals from the same wireless communication device for a predetermined time or more.

When specifying the two or more users U that behave together, the information processing apparatus 1 acquires information on the two or more users U from, for example, a user information database. The information on the users U is information on, for example, ages, genders, interests and concerns, workplaces of the users U, etc. The information processing apparatus 1 also can acquire, from a Social Networking Site server (SNS server) that provides social network service, information on the users U accumulated in the SNS server.

In this way, the information processing apparatus 1 acquires information on the users U from the user information database or the SNS server, and thus can precisely acquire the information on the users U compared with, for example, the case of determining attributes of each person on the basis of an amount of characteristics of the corresponding person's face images. Therefore, processes according to the relationships between the users U can be executed appropriately.

The information processing apparatus 1 determines the relationships between the two or more users U that behave together on the basis of the user information on the two or more users U that behave together. For example, in an example illustrated in FIG. 1, workplace of the users U₁ and U₂ is AB corporation. In other words, the users U₁ and U₂ work for the same AB corporation.

Accordingly, the information processing apparatus 1 determines that the relationships between the users U₁ and U₂ that behave together include “workmate”. The information processing apparatus 1 provides information according to the “workmate” to the one or more user(s) U among the users U₁ and U₂ that behave together. For example, the information processing apparatus 1 can provide to the user(s) U information geared toward business (for example, economic news, information on stock prices or exchange, etc.) as information according to “workmate”.

Therefore, appropriate topics are provided to the users U₁ and U₂ that behave together. Also, advertisement information on products or service related to business is provided to the users U₁ and U₂ that behave together, and thus advertisement effects of the advertisement information can be enhanced. Hereinafter, information that is provided by the information processing apparatus 1 may be referred to as content(s).

2. Configuration of Information Processing System

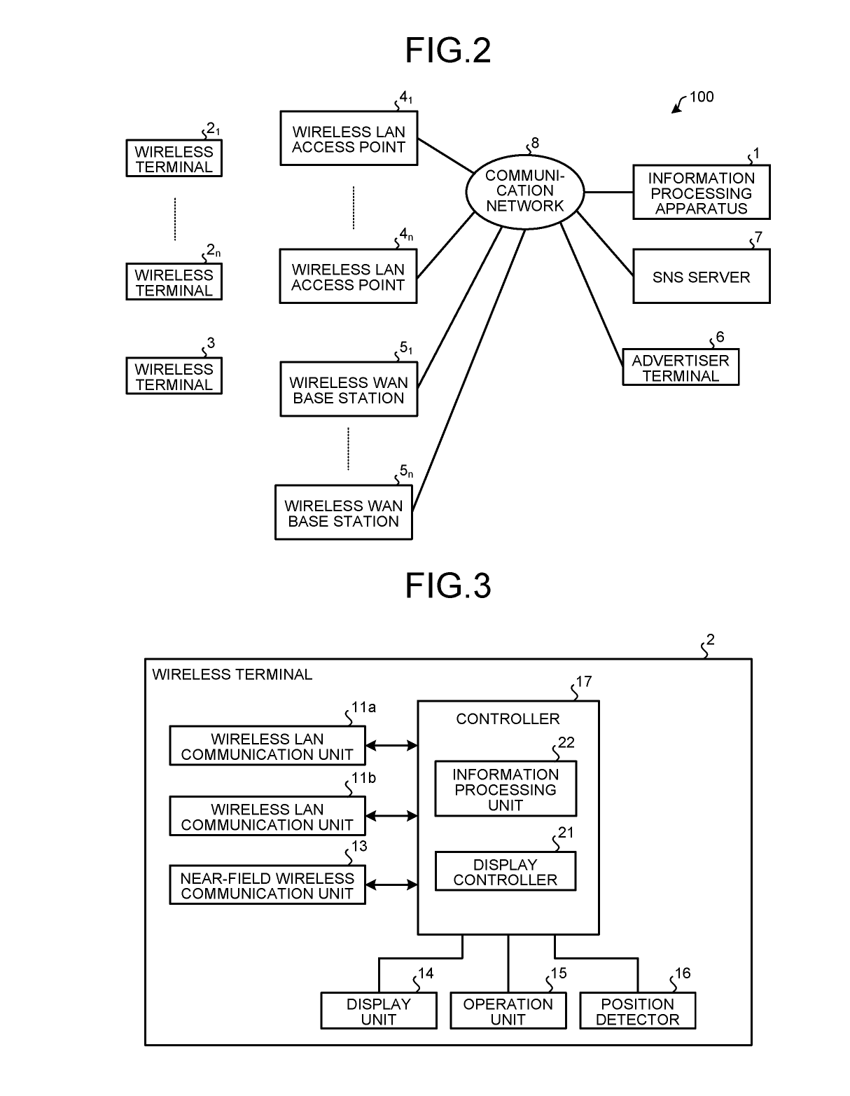

A configuration example of the information processing system 100 according to the embodiment will be explained with reference to FIG. 2. FIG. 2 is a diagram illustrating the configuration example of the information processing system 100 according to the embodiment.

As illustrated in FIG. 2, the information processing system 100 includes the information processing apparatus 1, the wireless terminals 2₁ to 2ₙ, a wireless terminal 3 (example of wireless communication unit), wireless Local Area Network access points (wireless LAN access points) 4₁ to 4ₙ, wireless Wide Area Network base stations (wireless WAN base stations) 5₁ to 5ₙ, an advertiser terminal 6, and a SNS server 7.

The information processing apparatus 1, the wireless terminals 2 and 3, the advertiser terminal 6, and the SNS server 7 can communicate with each other using a communication network 8 that includes the wireless LAN access points 4₁ to 4ₙ (hereinafter, may be referred to as wireless LAN access point(s) 4), the wireless WAN base stations 5₁ to 5ₙ (hereinafter, may be referred to as wireless WAN base station(s) 5).

The wireless terminals 2₁ to 2ₙ are wireless terminals of the respective users U₁ to Uₙ. The wireless terminal 3 is a wireless device that is mounted on, for example, a vehicle such as a taxi and a train. The wireless terminals 2 and 3 are, for example, portable wireless terminals such as smartphones and tablets.

The information processing apparatus 1 can specify the two or more users U that behave together on the basis of, for example, information transmitted from the wireless terminals 2₁ to 2ₙ. The information processing apparatus 1 provides contents to the wireless terminals 2 of the specified users U or the wireless terminal 3 mounted on a vehicle, in which the specified users U are getting, on the basis of relationships between the two or more users U specified as behaving together.

Hereinafter, information processing that is performed by the information processing system 100 will be specifically explained around information processing by the wireless terminals 2 and the information processing apparatus 1. Hereinafter, the wireless terminals 2 and the information processing apparatus 1 will be explained in this order.

3. Wireless Terminal

FIG. 3 is a diagram illustrating a configuration example of the wireless terminal 2. As illustrated in FIG. 3, the wireless terminal 2 includes a wireless LAN communication unit 11a, a wireless WAN communication unit 11b, a near-field wireless communication unit 13, a display unit 14, an operation unit 15, a position detector 16, and a controller 17.

The wireless LAN communication unit 11a sends/receives wireless signals to/from the wireless LAN access points 4. The wireless LAN includes, for example, a wireless LAN defined by IEEE802.11 or the like, but is not limited thereto.

The wireless WAN communication unit 11b sends/receives wireless signals to/from the wireless WAN base stations 5. The wireless WAN base stations 5 include, for example, wireless base stations of public telephone communication networks and wireless base stations of public telephone data networks. Hereinafter, the wireless LAN communication unit 11a and the wireless WAN communication unit 11b may be collectively referred to as a communication unit 11.

The near-field wireless communication unit 13 sends or receives wireless signals via near-field wireless communication. The near-field wireless communication unit 13 is a NFC unit that employs a communication method such as, for example, Felica, ISO/IEC 14443 (MIFARE), Bluetooth (Registered Trademark). The NFC may use, not limited to electrical waves, for example, infrared communication, visible light communication, sonic waves, or the like.

The display unit 14 is a touch panel type display. The user U of the wireless terminal 2 operates the top of a screen of the display unit 14 by fingers or the like to operate to the screen that is displayed at the display unit 14. The display unit 14 includes, for example, a compact Liquid Crystal Display (LCD) or an organic light emitting display.

The operation unit 15 includes a power button and a keyboard that includes keys for inputting letters, digits, and spaces, an enter key, arrow keys, or the like. The position detector 16 has a Global Positioning System receipt function (GPS receipt function) and acquires information on a present location and a moving speed of the wireless terminals 2. The information (hereinafter, may be referred to as location information) on the present location is information that indicates present latitude and longitude of the wireless terminals 2.

The controller 17 includes a display controller 21 and an information processing unit 22. The display controller 21 controls display contents of the display unit 14. For example, the display controller 21 can display a display screen on the display unit 14 on the basis of information acquired through the communication network 8 by the information processing unit 22 and display a display screen on the display unit 14, which is according to input operations by the operation unit 15.

The information processing unit 22 acquires information from the information processing apparatus 1, the SNS server 7, a Web server (not illustrated), or the like through the communication unit 11. The information processing unit 22 can send information and requests to the information processing apparatus 1, the SNS server 7 and the Web server through the communication unit 11.

For example, the information processing unit 22 can inform, using the communication unit 11, the information processing apparatus 1 of information on wave intensity of wireless signals (hereinafter, may be referred to as received wireless signals) received by the near-field wireless communication unit 13 or identifiers included in the received wireless signals as terminal detection information.

The identifier included in the received wireless signal is, for example, a Media Access Control address (MAC address), an Universally Unique IDentifier (UUID), etc., and may be referred to as a terminal ID hereinafter.

The information processing unit 22 can instruct the near-field wireless communication unit 13, for example, to send wireless signals periodically. The wireless signal includes information on the terminal ID that is different in each wireless terminal 2. The terminal ID is sometimes referred to as a beacon ID.

The information processing unit 22 can inform, using the communication unit 11, the information processing apparatus 1 of information on wave intensity of the received wireless signals and the terminal identifiers included in the received wireless signals as the terminal detection information. The terminal detection information includes the terminal ID (hereinafter, may be referred to as own terminal ID) that is included in the wireless signals that the information processing unit 22 causes the near-field wireless communication unit 13 to output.

Also, the information processing unit 22 can inform, using the communication unit 11, the information processing apparatus 1 of information on, for example, the terminal ID (hereinafter, may be referred to as other terminal ID) as the terminal detection information, which is included in the wireless signal having been received by the near-field wireless communication unit 13 from another wireless terminal 2 for a predetermined time or more at wave intensity of a predetermined value or more.

The information processing unit 22 can acquire the location information from the position detector 16 to inform the information processing apparatus 1 of the location information from the communication unit 11.

Also, the wireless terminal 3 includes a near-field wireless communication unit similar to the near-field wireless communication unit 13 and sends wireless signals periodically. Similarly to the case of the controller 17 of the wireless terminal 2, a controller of the wireless terminal 3 can inform the information processing apparatus 1 of the terminal detection information when the near-field wireless communication unit receives a wireless signal sent from other wireless terminal 2. The terminal detection information includes, for example, the terminal identifiers (other terminal identifiers) of the wireless terminals 2, the terminal ID (own terminal ID) of the wireless terminal 3, and the wave intensity. The wireless terminal 3 may have a similar configuration as that of the wireless terminal 2.

4. Information Processing Apparatus

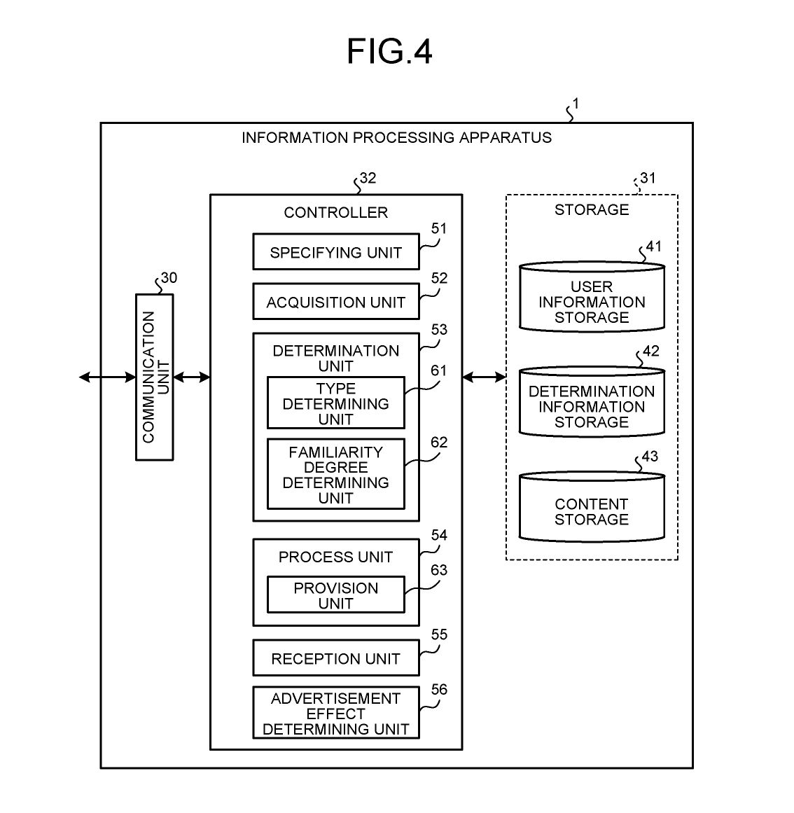

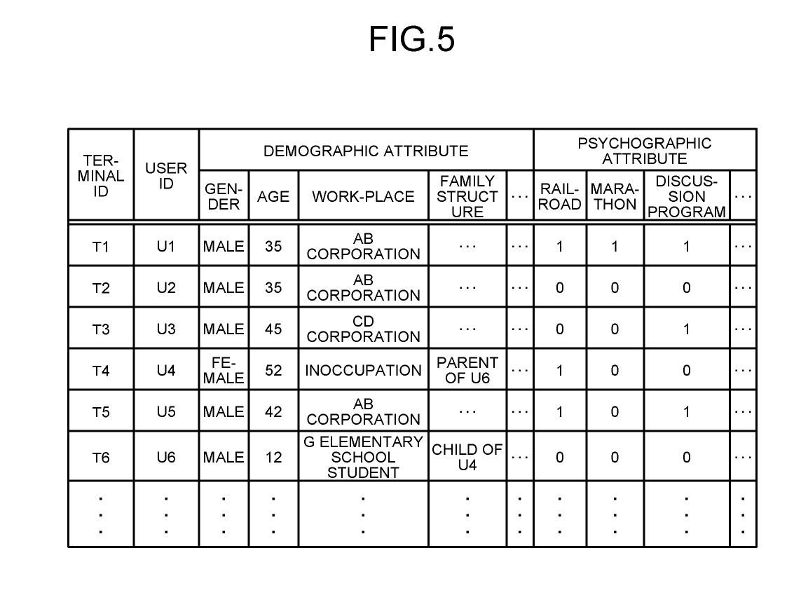

FIG. 4 is a diagram illustrating a configuration example of the information processing apparatus 1. As illustrated in FIG. 4, the information processing apparatus 1 includes a communication unit 30, a storage 31, and a controller 32.

4.1. Communication Unit

The communication unit 30 is an interface such as a Network Interface Card (NIC). The controller 32 sends/receives a variety of information to/from the wireless terminals 2 and 3 using the communication unit 30 and the communication network 8.

4.2. Storage

The storage 31 is a storage device such as a hard disk, a semiconductor memory device such as a Random Access Memory (RAM) or a flash memory, and an optical disk. The storage 31 includes a user information storage 41, a determination information storage 42, and a content storage 43.

The user information storage 41 storages a user information table that includes, for example, information (hereinafter, may be referred to as user information) on users U. FIG. 5 is a diagram illustrating an example of the user information table. As illustrated in FIG. 5, the user information table includes information in which “terminal ID”, “user ID”, “demographic attribute”, and “psychographic attribute” are associated with each other. The attribute information is illustrated as the user information in FIG. 0.5, however, the user information may include information on behavior histories of the users U.

“Terminal ID” is a terminal ID of the wireless terminal 2. “User ID” is information on an identifier that identifies the user U. The terminal identifiers are expressed by “T1”, “T2”, etc., and, for example, the user identifiers of the users U₁ and U₂ are expressed by “U1” and “U2” in the user information table illustrated in FIG. 5 for convenience sake, however, this information is added to facilitate understanding, and is not limited thereto.

“Demographic attribute” indicates demographic attribute information on the user U. The “demographic attribute” falls into attribute sections such as “gender”, “age”, “workplace”, and “family structure” of the user U. Information on the gender of the user U is set to “gender”. Information on the age of the user U is set to “age”. Information on the workplace of the user U is set to “workplace”. Information on the family relation of the user U is set to “family structure”. However not illustrated, “demographic attributes” includes, for example, various attribute sections such as annual income, an address, a hometown, and educational background of the user U.

“Psychographic attribute” is information that indicates sense of value, lifestyle, character, taste, etc. of the user U. “Psychographic attribute” falls into attribute sections such as “railroad”, “marathon”, and “discussion program”. In an example illustrated in FIG. 5, “1” is set for each attribute section when the taste of the user U for the corresponding attribute section is relatively high, otherwise, “0” is set. However, “−1” may be set for an attribute section when the user U dislikes the attribute section. Moreover, a value according to taste degree of the user U may be set for each of the attribute sections.

“Psychographic attributes” may include, not limited to the example of attribute sections illustrated in FIG. 5, various attribute sections such as politics, economics, baseball, soccer, other sports, sweets, a personal computer, major appliances, and furniture.

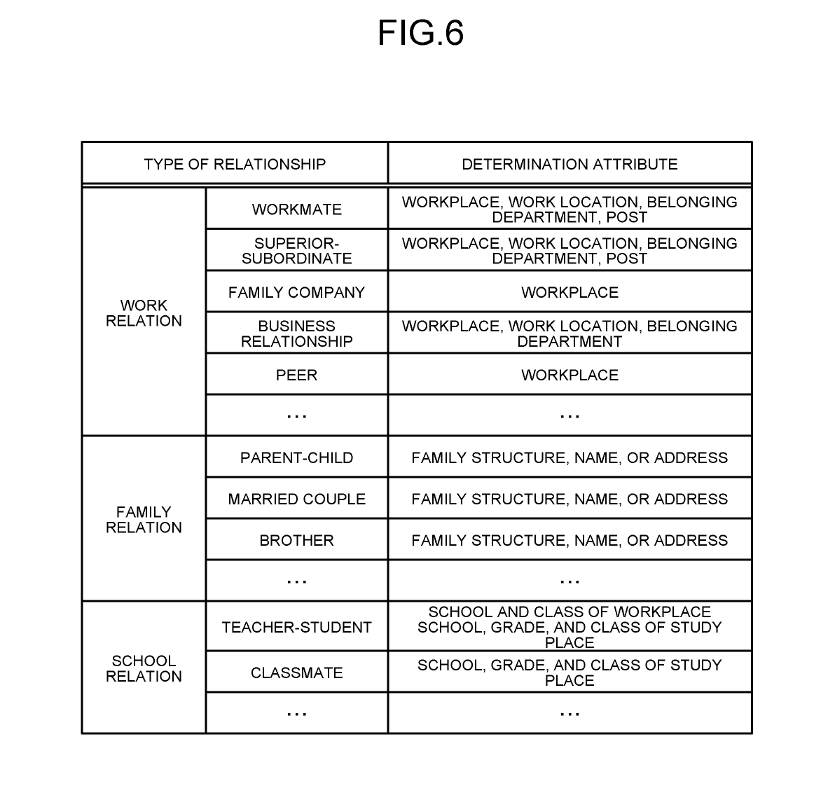

The determination information storage 42 stores a relationship type determination table, a familiarity degree determination table, a provision content determination table, etc. FIG. 6 is a diagram illustrating an example of the relationship type determination table. As illustrated in FIG. 6, information, in which “relationship type” and “determination attribute” are associated, is set in the relationship type determination table.

“Relationship type” is information that indicates a relationship type. “Work relation”, “family relation”, and “school relation” are set as sections of the relationship type, and an item of the relationship type is set with respect to each section of the relationship type. For example, “workmate”, “superior-subordinate”, “family company”, “business relationship”, “peer”, etc. are set as items of the relationship types in the section of “work relation”.

“Parent-child”, “married couple”, “brother”, etc. are set as items of the relationship types in the section of “family relation”. Also, “teacher-student”, “classmate”, etc. are set in the section of “school relation”.

“Determination attribute” includes attributes of the users U, by which relationships between the two or more users U that behave together are determined. For example, in an example illustrated in FIG. 6, whether or not being the item “workmate” of the section “work relation” is estimated by the controller 32 on the basis of the attribute information on “workplace, work location, belonging department, post” among attributes of the users U. For example, if the workplace, the work location, the belonging department, and the post are the same, a relationship between the two or more users U that behave together is estimated to be the workmate by the controller 32.

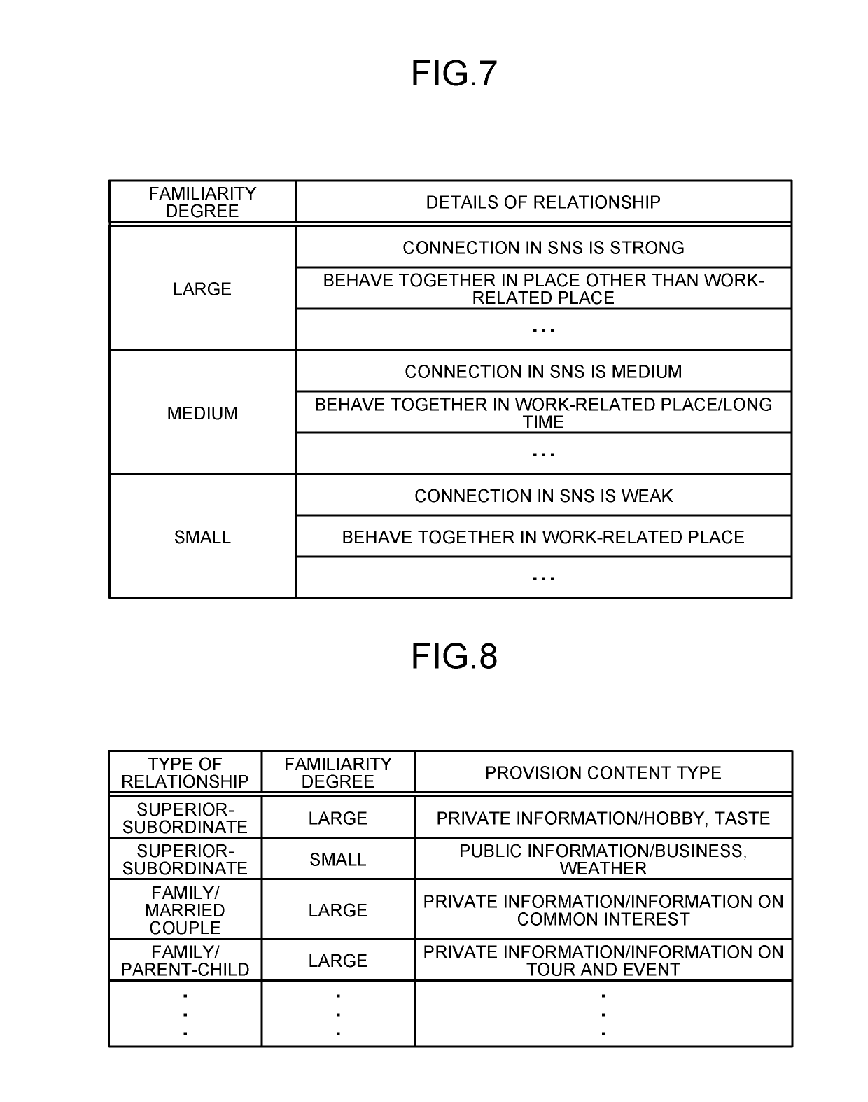

Next, the familiarity degree determination table will be explained. FIG. 7 is a diagram illustrating an example of the familiarity degree determination table. As illustrated in FIG. 7, information, in which “familiarity degree” and “relationship content” are associated, is set in the familiarity degree determination table.

“Familiarity degree” is information that indicates relationship degree, and is segmented into “large”, “medium”, and “small” in the descending order of the relationship degree. “Relationship content” includes relationship contents of the two or more users U that behave together. For example, in an example illustrated in FIG. 7, with respect to the two or more users U that behave together, when connections in SNS between them are strong, or they behave together in a place other than work-related places, the controller 32 determines that the familiarity degree is “large”.

Moreover, for example, with respect to the two or more users U that behave together, when connections in SNS between them are weak, or when they behave together in a work-related place, the controller 32 determines that the familiarity degree is “small”. In an example illustrated in FIG. 7, the familiarity degree is indicated by three steps of “large”, “medium”, and “small”, however may be indicated by four or more steps, or two steps.

Next, the provision content determination table will be explained. FIG. 8 is a diagram illustrating an example of the provision content determination table. As illustrated in FIG. 8, information, in which “relationship type”, “familiarity degree”, and “provision content type” are associated, is set in the provision content determination table.

“Relationship type” is information that is the same as that illustrated in FIG. 6. “Familiarity degree” is information that is the same as that illustrated in FIG. 7. “Provision content type” is information that indicates types of contents to be provided to the users U.

In an example illustrated in FIG. 8, when the relationship type is “superior-subordinate” and the familiarity degree is “large”, the controller 32 selects “private information (taste, hobby)” as a type of contents to be provided to the users U. Moreover, for example, when the relationship type is “superior-subordinate” and the familiarity degree is “small”, the controller 32 selects “public information (business, weather)” as a type of contents to be provided to the users U.

The content storage 43 stores information (hereinafter, may be referred to as link information) that indicates contents to be provided to the users U or storage positions of the contents. The contents to be provided to the users U include various contents such as news, articles of magazines, advertisements, and movies, and, for example, text data, static image data, moving image data, and animation data are included as data of the contents.

4.3. Controller

As illustrated in FIG. 4, the controller 32 includes a specifying unit 51, an acquisition unit 52, a determination unit 53, a process unit 54, a reception unit 55, and an advertisement effect determining unit 56. For example, a Central Processing Unit (CPU), a Micro Processing Unit (MPU), etc. executes a program stored in a storage that is inside of the controller 32 using an inside RAM (not illustrated) as a workspace, and thus functions of the specifying unit 51, the acquisition unit 52, the determination unit 53, the process unit 54, the reception unit 55, and the advertisement effect determining unit 56 are executed.

4.3.1. Specifying Unit

The specifying unit 51 specifies the two or more users U that behave together on the basis of terminal detection information that is sent from the wireless terminals 2. For example, when receiving a wireless signal for a predetermined time or more at wave intensity of a predetermined value or more, the specifying unit 51 specifies the two or more users U that behave together on the basis of the wave intensity, the other terminal ID, and the own terminal ID, which are included in the terminal detection information.

For example, when the users U₁ and U₂ are walking together, the wireless terminal 2₁ of the user U₁ continuously receives a wireless signal from the wireless terminal 2₂ of the user U₂, and thus wave intensity of the received wireless signal becomes a predetermined value or more. Similarly, the wireless terminal 2₂ continuously receives a wireless signal from the wireless terminal 2₁, and thus wave intensity of the received wireless signal becomes a predetermined value or more.

In this case, information on the own terminal ID “T1”, the other terminal ID “T2”, and wave intensity is included in the terminal detection information from the wireless terminal 2₁, and information on the own terminal ID “T2”, the other terminal ID “T1”, and wave intensity is included in the terminal detection information from the wireless terminal 2₂. Therefore, the specifying unit 51 can specify the two or more users U that behave together on the basis of the terminal detection information on one of the wireless terminals 2₁ and 2₂ or the terminal detection information on the wireless terminals 2₁ and 2₂.

Also, as described above, when receiving the wireless signal for a predetermined time or more at wave intensity of a predetermined value or more, the wireless terminals 2 can inform the information processing apparatus 1 of the terminal detection information. In this case, the specifying unit 51 can specify the two or more users U that behave together on the basis of the own terminal ID and the other terminal ID that are included in the terminal detection information. For example, when the terminal detection information includes the own terminal ID “T2” and the other terminal ID “T1”, the specifying unit 51 can determine that the users U₁ and U₂ behave together.

In this way, when the wireless signal has been sent and received for a predetermined time or more between the wireless terminals 2 that the two or more users U have respectively, the specifying unit 51 can determine that the two or more users U behave together. Also, the specifying unit 51 takes account of the wave intensity, and thus the users U that behave together can be specified precisely.

The specifying unit 51 can specify the users U of the two or more wireless terminals 2 as the users U that behave together, which simultaneously receive the wireless signals from the same wireless terminal 3 for a predetermined time or more.

For example, it is assumed that the terminal detection information that is sent from the wireless terminal 2₁ includes the own terminal ID “T1” and the other terminal ID “Tx”, and the terminal detection information that is sent from the wireless terminal 2₂ includes the own terminal ID “T2” and the other terminal ID “Tx”. “Tx” is a terminal ID of the wireless terminal 3. In this case, the specifying unit 51 can determine that the users U₁ and U₂ behave together.

Moreover, similarly to the wireless terminals 2, the wireless terminal 3 can send the terminal detection information. The terminal detection information includes the one or more terminal identifier(s) of the wireless terminal(s) 2, which transmit one or more wireless signal(s) to be simultaneously received by the wireless terminal 3, as the other terminal identifier(s). In this case, the specifying unit 51 can specify the users U that behave together on the basis of the terminal detection information that is sent from the wireless terminal 3.

For example, it is assumed that the terminal detection information that is sent from the wireless terminal 3 includes the own terminal ID “Tx” and the other terminal identifiers “T1” and “T2”. In this case, the specifying unit 51 can determine that the users U₁ and U₂ behave together.

Moreover, when the wireless terminals 2 do not send the terminal detection information, the specifying unit 51 can specify the two or more users U that behave together on the basis of the location information that is sent from the wireless terminals 2. For example, when positions of the wireless terminals 2₁ and 2₂ are within a predetermined range for a predetermined time or more, the specifying unit 51 can determine that the users U₁ and U₂ behave together on the basis of the terminal detection information from the wireless terminals 2₁ and 2₂.

When determining that the moving speed of the wireless terminals 2₁ and 2₂ is a predetermined value or more on the basis of the location information, the specifying unit 51 can determine that they are in public transportation such as a train and a bus, and can exclude a time in which they are in the public transportation. Therefore, the users U that behave together can be specified precisely.

4.3.2. Acquisition Unit

The acquisition unit 52 acquires user information (for example, attribute information, behavior history, etc.) of the two or more users U specified, by the specifying unit 51, as the users U that behave together. For example, when the specifying unit 51 specifies the users U₁ and U₂ as the users U that behave together, the acquisition unit 52 acquires user information of the users U₁ and U₂ among the user information stored in the user information storage 41.

The acquisition unit 52 can also acquire the attribute information of users U in a social network as user information of the two or more users U specified as the users U that behave together by the specifying unit 51. For example, the acquisition unit 52 can acquire, as the attribute information of the users U, information on profiles of the users U or information on connections between the users U from the SNS server 7 connected to the communication network 8. The acquisition unit 52 can also previously acquire the attribute information on the users U in the social network, and can store it in the user information storage 41.

The acquisition unit 52 may also acquire, from a search server connected to the communication network 8, the search history or the access history to a WEB server connected to the communication network 8 of the users U, determines attributes of the users U by the search history or the access history to acquire them as the attribute information and store them in the user information storage 41.

The acquisition unit 52 may also acquire the movement histories of the users U from the SNS server 7, the wireless terminals 2 and 3, etc. that are connected to the communication network 8, and store them in the user information storage 41 as the user information. The movement histories of the users U includes, for example, information on positions in which the users U move and the date and time when the users U move, and also includes information on present positions of the users U.

For example, the acquisition unit 52 may store, on the basis of the location information transmitted from the wireless terminals 2, in the user information storage 41 the movement histories of the users U, which is based on positions of the users U, as the user information. Positions to which the users U move and times when the users U move can be determined by postings to the SNS server 7 of the users U, and they can be stored in the user information storage 41 as the movement histories of the users U.

4.3.3. Determination Unit

The determination unit 53 determines, on the basis of the attribute information on the two or more users U, which is acquired by the acquisition unit 52, relationships between the two or more users U determined, by the specifying unit 51, that they behave together. The determination unit 53 includes a type determining unit 61 and a familiarity degree determining unit 62.

The type determining unit 61 can determine, on the basis of, for example, the relationship type determination table illustrated in FIG. 6, relationship types of the two or more users U determined by the specifying unit 51 that behave together.

For example, the type determining unit 61 can determine whether or not relationship types of the two or more users U are relationships of “superior-subordinate” in “work relation” on the basis of information of “workplace”, “work location”, “belonging department”, and “post” among the attribute information, which is acquired by the acquisition unit 52, on the two or more users U.

For example, when “workplace”, “work location”, and “belonging department” are the same and “post” is different in the attribute information acquired by the acquisition unit 52, the type determining unit 61 determines that the two or more users U determined, by the specifying unit 51, that they behave together are in a relation of superiors and subordinates in business.

When a category of business with respect to “workplace” in the attribute information acquired by the acquisition unit 52, the type determining unit 61 determines that the two or more users U determined, by the specifying unit 51, that they behave together are in a relation of peers.

The type determining unit 61 can also determine whether or not a type of relationship between the two or more users U is any one relation of “parent-child”, “married couple”, or “brother” in “family relation” on the basis of “name”, “address”, or “family structure” in the attribute information acquired by the acquisition unit 52.

For example, when the users U₄ and U₆ are determined to be users U that behave together by the specifying unit 51, and the user information table is in a state illustrated in FIG. 5, the type determining unit 61 determines that the users U determined, by the specifying unit 51, that behave together are in a relation of parent-child.

Moreover, in the aforementioned example, the type determining unit 61 determines types and items of relationships between the two or more users U on the basis of the attribute information of the users U, the type determining unit 61 can also determine types and items of relationships between the two or more users U on the basis of the behavior histories of the users U.

For example, when determining that two or more users U go to a certain high school together from the behavior histories of the users U, the type determining unit 61 can determine them to be in school relation. Moreover, the type determining unit 61 can also determine whether or not the users U are classmates from their ages or the like.

The familiarity degree determining unit 62 can determine, on the basis of, for example, the familiarity degree determination table illustrated in FIG. 7, familiarity degree that is relationship degree of two or more users U determined, by the specifying unit 51, that they behave together.

The familiarity degree determining unit 62 can determine, on the basis of information acquired from the SNS server 7 by the acquisition unit 52, connection degree between the two or more users U determined, by the specifying unit 51, that they behave together.

For example, the familiarity degree determining unit 62 can determine connection strength in SNS in accordance with frequency (hereinafter, referred to as communication frequency) of comment postings and responses on the SNS between the two or more users U determined, by the specifying unit 51, that they behave together. For example, when the communication frequency between the users U is high, the familiarity degree determining unit 62 determines that the familiarity degree is large. When the communication frequency between the users U is low, the familiarity degree determining unit 62 determines that the familiarity degree is small. When the communication frequency between the users U is medium, the familiarity degree determining unit 62 determines that the familiarity degree is medium.

The familiarity degree determining unit 62 can also determine the familiarity degree between the two or more users U determined, by the specifying unit 51, that they behave together on the basis of the behavior histories of the users U, which are acquired by the acquisition unit 52.

For example, when the two or more users U, which are determined that they behave together by the specifying unit 51, behave together in a place other than work-related places, the familiarity degree determining unit 62 can determine that the familiarity degree is large. When the two or more users U, which are determined that they behave together by the specifying unit 51, behave together in a work-related place, the familiarity degree determining unit 62 can determine that the familiarity degree is small.

When a plurality of “relationship contents” exists, and they respectively correspond to the familiarity degrees that differ from each other, the familiarity degree determining unit 62 can prioritize the familiarity degree whose degree is the largest. For example, when connections in SNS between the two or more users U determined that they behave together by the specifying unit 51 are strong, the familiarity degree determining unit 62 can determine that the familiarity degree is large even if they behave together in a work-related place.

The familiarity degree determining unit 62 can also determine, on the basis of information on the movement history in the attribute information on the two or more users U acquired by the acquisition unit 52, the familiarity degree depending on whether the two or more users U specified as behaving together move by a private car or a company car.

For example, when the two or more users U specified as behaving together move by a private car, the familiarity degree determining unit 62 determines that the familiarity degree is “large”. When the two or more users U specified as behaving together move by a company car, the familiarity degree determining unit 62 determines that the familiarity degree is “small”. For example, the acquisition unit 52 acquires identifiers, which are included in wireless signals from a near field wireless communication device provided in a car, from the wireless terminals 2 and 3, and thus by which car the users U move can be determined by, for example, the determination unit 53.

The familiarity degree determining unit 62 statistically handles connections in SNS, behavior places, moving units, etc. comprehensively, and can determine the familiarity degree between the two or more users U specified as behaving together.

The determination unit 53 can also determine relationships between some of the users U among the two or more users U determined, by the specifying unit 51, that they behave together. The determination unit 53 can also divide the two or more users U determined, by the specifying unit 51, that they behave together into a plurality of groups, and determine relationships between the users U that belong to each group.

The determination unit 53 can also determine, for example, all of the relationships between the two or more users U, which are determined that they behave together by the specifying unit 51, divide them into a plurality of groups, and further determine relationships between the users U that belong to each group.

The determination unit 53 can also determine relationships between the users U on the basis of only user information of the users U in a social network. The determination unit 53 can also determine relationships between the users U on the basis of only user information stored in the user information storage 41.

Moreover, one of the type determining unit 61 and the familiarity degree determining unit 62 determines relationships between the users U on the basis of only the attribute information on the users U in a social network, the other can determine relationships between the users U on the basis of only user information stored in the user information storage 41.

4.3.4. Process Unit

The process unit 54 illustrated in FIG. 4 acquires information on relationships between the two or more users U specified as behaving together from the determination unit 53, and executes processes according to the relationships.

The process unit 54 includes a provision unit 63. The provision unit 63 can acquire, from the content storage 43, a content according to the relationships between the two or more users U specified as behaving together, and transmit the content from the communication unit 30 to the wireless terminals 2 of at least one or more users U among the two or more users U specified as behaving together. Therefore, the users U of the wireless terminals 2 can acquire, by the wireless terminals 2, the content according to the relationships between the two or more users U specified as behaving together.

The provision unit 63 can also transmit from the communication unit 30 link information of the content according to relationships between the two or more users U specified as behaving together to the wireless terminal(s) 2 of at least one or more user(s) U among the two or more users U specified as behaving together.

In this case, the wireless terminal 2 acquires the link information, and then acquires, on the basis of the link information, a content from the information processing apparatus 1 or a server via the communication network 8. For example, when a transmission request, which is based on link information, of a content from the wireless terminal 2 exists, the provision unit 63 can acquire the content according to the transmission request from the content storage 43, and transmit the content from the communication unit 30 to the wireless terminals 2 of requestors.

The provision unit 63 can execute processes according to the relationships between the two or more users U specified as behaving together on the basis of the provision content determination table stored in the determination information storage 42. For example, it is assumed that the user information table is in such a state that is illustrated in FIG. 5, the provision content determination table is in such a state that is illustrated in FIG. 8, and the two or more users U specified as behaving together are the users U₁ and U₅.

In this case, the determination unit 53 determines that the relationship type is “superior-subordinate” and the familiarity degree is “large”, and then the provision unit 63 provides to the users U₁ and U₅ a content regarding a hobby or a taste included in private information (hereinafter, may be referred to as private content). For example, because both the users U₁ and U₅ have an attribute of being fond of “railroad”, the provision unit 63 provides a content regarding railroad to the users U₁ and U₅ on the basis of the attribute information on the users U₁ and U₅.

On the contrary, when the determination unit 53 determines that the relationship type is “superior-subordinate” and the familiarity degree is “small”, the provision unit 63 provides public information (hereinafter, may be referred to as public content) to the users U₁ and U₅. The provision unit 63 can provide, as a public content, common or official topics such as information on business and weather news.

In this way, because the provision unit 63 can provide a content according to the familiarity degree, even if the two or more users U specified as behaving together are in a relation of “superior-subordinate”, the provision unit 63 can appropriately execute processes according to relationships between the users U.

In the aforementioned example, the provision unit 63 provides to the users U a content according to relationship types and familiarity degree of the two or more users U specified as behaving together, however, the provision unit 63 may also provide to the users U a content according to one of the relationship type and the familiarity degree.

When a predetermined number or more contents are provided to the two or more users U specified as behaving together, the provision unit 63 can also change the priority order of the contents to be provided on the basis of at least one of the relationship type and the familiarity degree of the two or more users U specified as behaving together. The priority order of the contents includes, for example, provision order to the wireless terminals 2 and 3, or display order on the display units 14 of the wireless terminals 2 and 3. The display order on the display units 14 of the wireless terminals 2 and 3 includes the alignment order on the display screens.

The provision unit 63 can also transmit contents to the wireless terminals 2 of the two or more users U specified as behaving together. Therefore, the users U can check the contents with the respective wireless terminals 2 of the users U.

The provision unit 63 can also transmit contents to the wireless terminals 2 of some of the users U among the two or more users U specified as behaving together in accordance with setting (hereinafter, referred to as user setting) by administrators of the information processing apparatus 1 or the users U of the wireless terminals 2.

For example, when the number of the two or more users U specified as behaving together exceeds a predetermined number (for example, two), the provision unit 63 can transmit contents to the predetermined number (for example, two) of the wireless terminals 2 of the users U in accordance with the user setting. The provision unit 63 can transmit, in accordance with the user setting, contents to the wireless terminals 2 of the users U of a certain ratio to the total number of the two or more users U specified as behaving together.

When contents are provided to all of the users U in such a case that the number of the two or more users U specified as behaving together is large, unpleasant feelings may be given to the users U. However, as described above, unpleasant feelings to be given to the users U can be reduced by narrowing down the users U to be provided the contents.

A content providing method to the two or more users U specified as behaving together by the provision unit 63 will be here explained. The provision unit 63 can execute pull-system information provision to the two or more users U specified as behaving together, and can also execute push-system information provision.

In the case of the pull-system information provision, when a content request is executed to the information processing apparatus 1 by the wireless terminals 2 of the two or more users U specified as behaving together (hereinafter, may be referred to as two or more group users GU), the provision unit 63 can provide contents on the basis of relationships between the two or more group users GU.

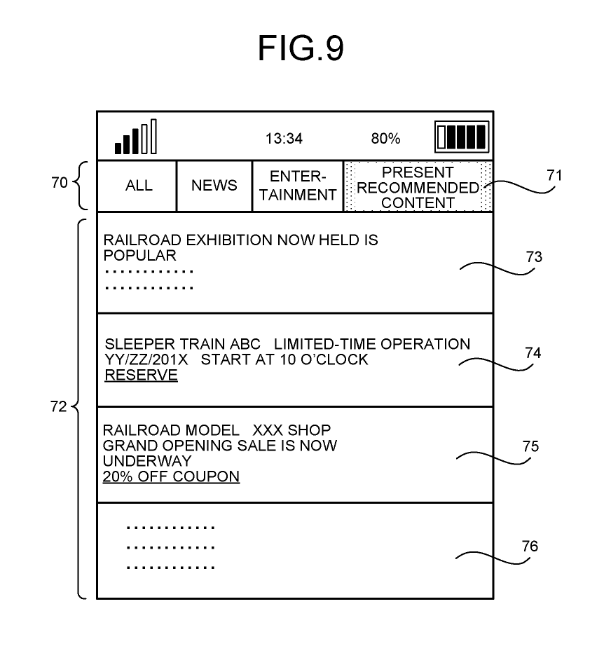

FIG. 9 is a diagram illustrating a contents example, which are transmitted from the provision unit 63 to the wireless terminals 2 using the pull-system information provision, and are displayed on display screens of the wireless terminals 2. A display screen illustrated in FIG. 9 includes a tab area 70 and a content area 72.

In the tab area 70, “all”, “news”, “entertainment”, “present recommended content”, etc. are displayed as tabs. When the user U of the wireless terminal 2 operates the operation unit 15, the display unit 14, etc., and selects a tab 71 of “present recommended content”, contents 73 to 76, which are according to relationships between the two or more group users GU, are displayed in the content area 72.

In an example illustrated in FIG. 9, a content of news regarding a railroad exhibition is displayed as the content 73. A content of news regarding an advertisement of a sleeper train ABC is displayed as the content 74. A content of an advertisement or a coupon of railroad models is displayed as the content 75.

On the other hand, in the case of the push-system information provision, contents according to relationships between the two or more group users GU can be provided, not depending on operations of the group users GU, to the wireless terminals 2 of the two or more group users GU. In the push-system information provision, contents provided from the provision unit 63 include, similarly to the pull-system information provision, contents of news, advertisements, coupons, etc.

When specifying the two or more users U that behave together on the basis of the terminal ID of the wireless terminal 3, the provision unit 63 can transmit contents or link information on the contents, which are selected by the determination unit 53, to the wireless terminal 3.

For example, when the wireless terminal 3 is provided in a vehicle of a taxi, contents corresponding to combinations of attributes of the two or more users U that are getting on the taxi can be displayed, to the users U, on the display units 14 of the wireless terminals 2 or the display unit of the wireless terminal 3

In the aforementioned example, the process unit 54 provides contents according to relationships between the two or more users U specified as behaving together to the users U, however, other processes according to the relationships between the two or more users U specified as behaving together can also be executed.

For example, when providing shopping pages in response to requests from the two or more users U specified as behaving together, the provision unit 63 can provide shopping pages according to relationships between the two or more users U specified as behaving together.

For example, in such a case that the relationships between the two or more users U specified as behaving together include the married couple, the provision unit 63 can provide shopping pages, which include package tours exclusively for married couples, to the users U when the provision unit 63 provides package tours in the shopping pages.

The provision unit 63 can provide, to the users U, shopping pages that provides products or services at discount rates according to relationships between the two or more users U specified as behaving together. In such a case that the products include financial products or insurance products, the provision unit 63 can provide, to the users U, shopping pages in which interest rates and insurance rates according to the relationships between the two or more users U specified as behaving together are set.

When the two or more users U specified as behaving together are in a predetermined shop, the provision unit 63 can provide, to an information processing apparatus (for example, POS apparatus) provided in the predetermined shop, information that indicates the relationships between the two or more users U specified as behaving together. Therefore, the information processing apparatus provided in the predetermined shop can execute processes according to the relationships between the two or more users U specified as behaving together.

For example, the provision unit 63 can discount products or the services, or suspend sale of products or services in accordance with the relationships between the two or more users U specified as behaving together. For example, in such a case that the two or more users U specified as behaving together are parent-child, the provision unit 63 can provide products or services, to which parent-child discounts are executed by the information processing apparatus provided in the predetermined shop.

When the two or more users U specified as behaving together are to go into a predetermined shop, the provision unit 63 can, for example, prohibit them from going into the shop by the information processing apparatus on the basis of the relationships between the two or more users U specified as behaving together.

For example, when the relationships between the two or more users U specified as behaving together include a predetermined relationship, the information processing apparatus provided in the predetermined shop can keep doors of the predetermined shop closed, or display indication that indicates prohibition of their entering the shop on a display device at an entrance of the shop.

4.3.5. Reception Unit

The reception unit 55 (example of advertisement information acquiring unit) receives advertisement requests from each of the one or more advertiser terminal(s) 6 using the communication network 8.

The advertisement request includes, advertisement contents, provision content type information, target attribute information, etc. and the reception unit 55 stores information, which is included in advertisement requests, in the content storage 43. For example, the reception unit 55 can store the advertisement contents, the provision content type information, and the target attribute information, which are included in the advertisement requests, in the content storage 43 with them being associated with each other. The provision unit 63 can provide the advertisement contents on the basis of provision content type information or target attribute information.

4.3.6. Advertisement Effect Determining Unit

In accordance with response to advertisement contents by at least one or more user(s) U to which the advertisement content, which is provided by the provision unit 63, is provided, the advertisement effect determining unit 56 determines advertisement effects by the advertisement content.

For example, when the user U operates the operation unit 15 or the display unit 14 to select the content 74 and make a train reservation in such a state that the content illustrated in FIG. 9 is displayed on the display screen of the wireless terminal 2, the advertisement effect determining unit 56 can determine generation of a conversion.

When the user U operates the operation unit 15 or the display unit 14 to select the content 75 and acquires a coupon in such a state that the content illustrated in FIG. 9 is displayed on the display screen of the wireless terminal 2, the advertisement effect determining unit 56 can determine generation of a conversion.

In this way, the advertisement effect determining unit 56 can determine the advertisement effects of the advertisement content provided by the provision unit 63. Moreover, the advertisement effect determining unit 56 can update a history of conversions to advertisement contents when a conversion is generated.

5. Process Flow of Information Processing Apparatus

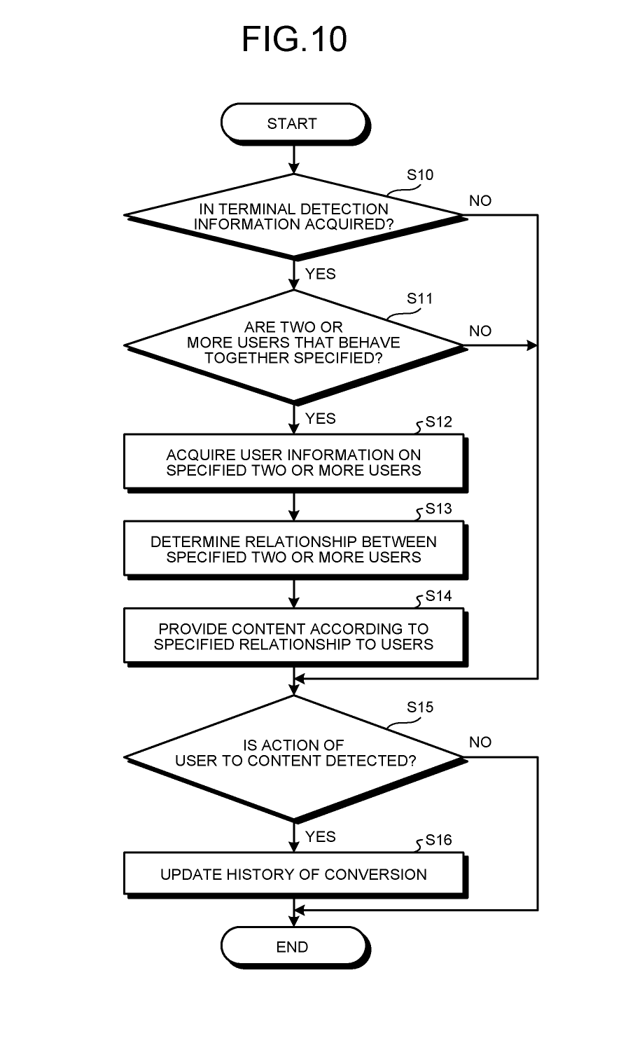

Next, an information processing procedure of the information processing apparatus 1 according to the embodiment will be explained. FIG. 10 is a flowchart illustrating an example of information processing in the information processing apparatus 1.

As illustrated in FIG. 10, the controller 32 determines whether or not the terminal detection information is acquired from the wireless terminals 2 and 3 using the communication unit 30 (Step S10). When the terminal detection information is determined to be acquired (Step S10: Yes), the controller 32 determines whether or not the two or more users U that behave together are specified on the basis of the acquired terminal detection information (Step S11).

When the two or more users U that behave together are specified (Step S11: Yes), the controller 32 acquires the user information on the specified two or more users U from the storage 31 (Step S12). Next, the controller 32 determines relationships between the specified two or more users U on the basis of the user information on the specified two or more users U (Step S13), and provides to the users U contents according to the relationships between the specified two or more users U (Step S14).

The procedure is shifted to Step S15 in such a case that the procedure of Step S14 is completed, the terminal detection information is not acquired in Step S10 (Step S10: No), or the two or more users U that behave together are not specified in Step S11 (Step S11: No).

In Step S15, the controller 32 detects whether or not the users U make an action to the provided contents. For example, the controller 32 can detect an action of the user U, which is operating the operation unit 15 of the wireless terminal 2 to select “reserve”, in such a state that contents illustrated in FIG. 9 are displayed on the display screen of the wireless terminal 2.

When the action of the user U to the provided contents is detected (Step S15: Yes), the controller 32 updates a conversion history regarding the contents to which the action is made (Step S16). In such a case that the procedure of Step S16 is completed, or the action of the user U is not detected in Step S15 (Step S15: No), the controller 32 terminates the procedures illustrated in FIG. 10.

6. Modified Example

Information on intensity of waves transmitted from the wireless terminals 2 may not be the wave intensity itself, and may be, for example, three-steps information of strong, middle, and weak wave intensity. In this case, when the wave intensity of the wireless signals, which one of the wireless terminals 2₁ and 2₂ receives, is “strong” or “middle”, the specifying unit 51 can determine that the users U₁ and U₂ behave together.

In the aforementioned embodiment, as an example, the controller 32 of the information processing apparatus 1 is explained to provide to the users U contents according to relationships between the two or more users U specified as behaving together, however is not limited thereto.

For example, the controller 32 can also request the content server from the provision unit 63 to transmit contents that include information indicating the relationships between the two or more users U specified, by the specifying unit 51, as behaving together. The content server transmits the contents to the wireless terminals 2 or the wireless terminal 3 on the basis of a content transmission request. Therefore, the controller 32 can provide to the users U contents according to relationships between the two or more users U that behave together.

In the aforementioned embodiment, an example in which the wireless terminal 3 is mounted on the vehicle is explained, however, the wireless terminal 3 can be provided in, for example, a commercial space such as a restaurant, a hotel, a hair salon/barber, a hospital, a theater, and a combined leisure facility. Moreover, the wireless terminal 3 also may be a digital signage.

In the aforementioned embodiment, the two or more users U are specified, which behave together, on the basis of the terminal detection information acquired from the wireless terminals 2 or the wireless terminal 3, or the location information acquired from the wireless terminals 2, however, not limited thereto. For example, the specifying unit 51 can specify two or more users U that behave together on the basis of the positions of the wireless terminals 2 detected at the wireless LAN access point 4 or the wireless WAN base station 5.

Also, the specifying unit 51 specifies present positions of the users U by, for example, a positioning technology using geomagnetic data, and thus the two or more users U that behave together can be specified. For example, a geomagnetic sensor is provided in the position detector 16 of the wireless terminal 2, and a matching process between the geomagnetic data acquired by the geomagnetic sensor and a geomagnetic database previously stored in the position detector 16 is executed, and thus the position detector 16 can specify the present positions of the wireless terminals 2. The specifying unit 51 acquires from the wireless terminals 2 information that indicates the present positions of the wireless terminals 2 specified in this way, and thus, similarly to the case of the location information of the aforementioned GPS, the two or more users U that behave together can be determined on the basis of the information. The geomagnetic database may be stored in the storage 31 of the information processing apparatus 1, and the specifying unit 51 of the information processing apparatus 1 can acquire the geomagnetic data from the wireless terminals 2 to specify present positions of the wireless terminals 2 on the basis of the geomagnetic database.

In the aforementioned embodiment, an example in which the wireless terminal 3 is the portable wireless terminal such as a smartphone and a tablet is explained, however, a wireless apparatus, instead of the wireless terminal 3, which has only function of periodically sending wireless signals using the NFC may be sufficient.

In the aforementioned embodiment, attribute information on the users U is acquired from the user information storage 41 of the information processing apparatus 1, however, the attribute information on the users U may be stored in the wireless terminal 2, and the information processing apparatus 1 may acquire the attribute information on the users U from the wireless terminals 2.

7. Hardware Configuration

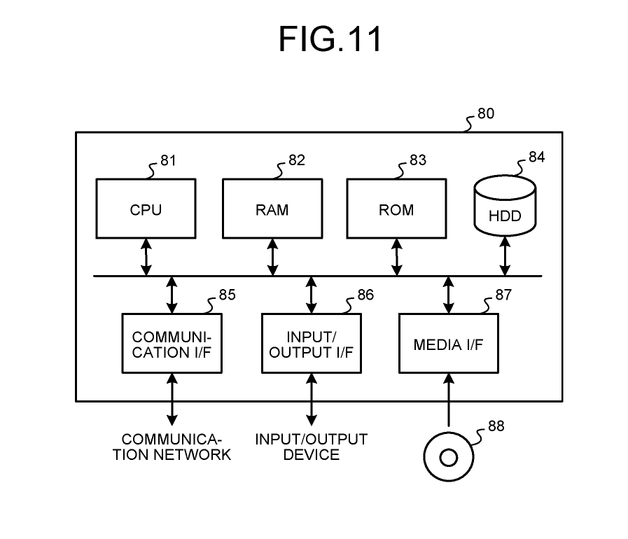

The information processing apparatus 1, the wireless terminals 2 and the wireless terminal 3 in the embodiment are realized by, for example, a computer 80 of a configuration illustrated in FIG. 11. FIG. 11 is a diagram illustrating a hardware configuration example of a computer that realizes functions of the information processing apparatus 1, the wireless terminals 2, and the wireless terminal 3. The computer 80 includes a Central Processing Unit (CPU) 81, a Random Access Memory (RAM) 82, a Read Only Memory (ROM) 83, a Hard Disk Drive (HDD) 84, a communication interface (I/F) 85, an input/output interface (I/F) 86, and a media interface (I/F) 87.

The CPU 81 operates on the basis of a program stored in the ROM 83 or HDD 84, and controls each unit. The ROM 83 stores a boot program that is executed by the CPU 81 at the start of the computer 80, programs that depend on hardware of the computer 80, etc.

The HDD 84 stores programs that are executed by the CPU 81, data that are used by the programs, or the like. The communication interface 85, corresponding to the communication unit 11 or the communication unit 30, receives data from other devices through the communication network 8, sends the data to the CPU 81, and sends data generated by the CPU 81 to other devices through the communication network 8.

The CPU 81 controls an output device such as a display and a printer and an input device such as a keyboard and a mouse through the input/output interface 86. The CPU 81 acquires data from the input device through the input/output interface 86. The CPU 81 outputs generated data to the output device through the input/output interface 86.

The media interface 87 reads a program or data stored in a record medium 88, and provide them to the CPU 81 through the RAM 82. The CPU 81 loads the program from the record medium 88 onto the RAM 82 through the media interface 87, and executes the loaded program. The record medium 88 is an optical record medium such as a Digital Versatile Disc (DVD) and a Phase change rewritable Disk (PD), an optical magnetic record medium such as a Magneto-Optical disk (MO), a tape medium, a magnetic-record medium, a semiconductor memory, etc.

When the computer 80 functions as the information processing apparatus 1, the CPU 81 of the computer 80 executes the program loaded on the RAM 82, and thus realizes each of the functions of the specifying unit 51, the acquisition unit 52, the determination unit 53, the process unit 54, the reception unit 55, and the advertisement effect determining unit 56. The HDD 84 realizes functions of the storage 31, and stores the user information table, the relationship type determination table, the familiarity degree determination table, the provision content determination table, etc.

When the computer 80 functions as the wireless terminals 2 and 3, the CPU 81 of the computer 80 executes the program loaded on the RAM 82, and thus each of the functions of the display controller 21 and the information processing unit 22 is realized.

The CPU 81 of the computer 80 reads these programs from the record medium 88 to execute them, however, may acquire the programs from other devices using the communication network 8 as another example.

8. Effects

The information processing apparatus 1 of the information processing system 100 according to the embodiment includes the specifying unit 51, the acquisition unit 52, the determination unit 53, and the process unit 54. The specifying unit 51 specifies two or more users U that behave together. The acquisition unit 52 acquires information on the two or more users U specified by the specifying unit 51 from the database (for example, user information storage 41 or SNS server 7) that stores information on a plurality of the users U. The determination unit 53 determines relationships between the two or more users U on the basis of information on the two or more users U acquired by the acquisition unit 52. The process unit 54 executes processes according to the relationships, which are determined by the determination unit 53, between the two or more users U.

In this way, because the controller 32 acquires information on the users U from the database such as a user information database or the SNS server 7, the relationships between a plurality of the users U can be determined appropriately compared with, for example, the case of determining attributes of each person on the basis of an amount of characteristics of the corresponding person's face image. Therefore, processes according to the relationships between the users U can be executed appropriately.

The process unit 54 includes the provision unit 63 that provides information, which is according to the relationships between the two or more users U determined by the determination unit 53, to at least one or more user(s) U among the two or more users U. Therefore, contents according to the relationships between the users U can be provided to the users U.

The determination unit 53 determines, as relationships, types of the relations between the two or more users U and/or the familiarity degrees between the two or more users U. The process unit 54 executes processes according to the types and/or the familiarity degrees determined by the determination unit 53. Therefore, the relationships between the users U can be determined more appropriately, and the processes according to the relationships between the users U can be executed. For example, by determining the relationship types and the familiarity degrees, and further selecting contents according to the relationship types and the familiarity degrees, more appropriate contents can be provided to the users U.

The determination unit 53 determines the types and/or the familiarity degrees on the basis of information on two or more users U in social networks. In this way, because the types and/or the familiarity degrees are determined on the basis of information from the social networks, the relationships between the users U can be determined more easily on the basis of, for example, postings to the social networks

The determination unit 53 determines the types and/or the familiarity degrees on the basis of behavior histories of two or more users U. In this way, because the types and/or the familiarity degrees are determined on the basis of the behavior histories, even if, for example, postings to the social networks do not exist, the relationships between the two or more users U can be determined on the basis of behaviors of the users U.

The specifying unit 51 specifies two or more users U that behave together among a plurality of users U on the basis of wireless signals that are received by the respective wireless terminals 2 of the plurality of users U. Therefore, the users U that behave together can be determined easily.

When the wireless signals are transmitted and received for a predetermined time or more between the respective wireless terminals 2 of two or more users U, the specifying unit 51 determines that the two or more users U behave together. Therefore, the users U that behave together can be determined easily among the users U of the wireless terminals 2 without, for example, providing separate equipment.

When the respective wireless terminals 2 of two or more users U are receiving wireless signals for a predetermined time or more from the same wireless terminal 3 (example of wireless communication unit), the specifying unit 51 determines that the two or more users U behave together. Therefore, for example, by providing the wireless terminal 3, the users U that behave together can be easily determined among the users U that have the wireless terminals 2.

The specifying unit 51 specifies two or more users that behave together from positions of the users U specified based on geomagnetic data detected by the wireless terminals 2 of the users U. Therefore, the positions of the users U can be detected precisely, for example, in a building or an underground place in which position detection by GPC is difficult.

9. Others

The configuration of the aforementioned information processing apparatus 1 may be changed flexibly. For example, the information processing apparatus 1 may be realized by a plurality of server computers, or, depending on functions, may be realized by calling an external platform or the like by using an Application Programming Interface (API) or network computing or the like.

Moreover, arrows illustrated in FIGS. 1, 3, 4, etc. accessorily indicate the flows of data, controls, etc., and are not intended to deny other flows and to mean limitation of their directions.

According to one aspect of an embodiment, an information processing apparatus, an information processing method, and a non-transitory computer readable storage medium, which can appropriately execute processes according to relationships between users.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a specifying unit that specifies two or more users that behave together;
an acquisition unit that acquires information on the two or more users specified by the specifying unit from a database that stores information on a plurality of users;
a determination unit that determines a relationship between the two or more users based on the information on the two or more users acquired by the acquisition unit; and
a process unit that executes a process according to the relationship between the two or more users determined by the determination unit.

2. The information processing apparatus according to claim 1, wherein the process unit includes a provision unit that provides information according to the relationship between the two or more users determined by the determination unit to at least one of the two or more users.

3. The information processing apparatus according to claim 1, wherein
the determination unit determines, as the relationship, a type of a relation between the two or more users and/or a familiarity degree between the two or more users, and
the process unit executes a process according to the type and/or the familiarity degree determined by the determination unit.

4. The information processing apparatus according to claim 3, wherein the determination unit determines the type and/or the familiarity degree based on information on the two or more users in a social network.

5. The information processing apparatus according to claim 3, wherein the determination unit determines the type and/or the familiarity degree based on behavior histories of the two or more users.

6. The information processing apparatus according to claim 1, wherein the specifying unit specifies the two or more users that behave together from among a plurality of users based on wireless signals received by respective wireless terminals of the plurality of users.

7. The information processing apparatus according to claim 6, wherein the specifying unit determines that the two or more users behave together when the wireless signals are transmitted and received for a predetermined time or more between the respective wireless terminals of the two or more users.

8. The information processing apparatus according to claim 6, wherein the specifying unit determines that the two or more users behave together when the respective wireless terminals of the two or more users receive wireless signals from a same wireless communication unit for a predetermined time or more.

9. The information processing apparatus according to claim 1, wherein the specifying unit specifies the two or more users that behave together from positions of the users, the positions being specified based on geomagnetic data detected by wireless terminals of the users.

10. A non-transitory computer readable storage medium having stored therein an information processing program, the program causing a computer to execute a process comprising:
specifying two or more users that behave together;
acquiring information on the two or more users specified in the specifying from a database that stores information on a plurality of users;
determining a relationship between the two or more users based on the information on the two or more users acquired in the acquiring; and
executing a process according to the relationship between the two or more users determined in the determining.

11. An information processing method that is performed by a computer, the method comprising:
specifying two or more users that behave together;
acquiring information on the two or more users specified in the specifying from a database that stores information on a plurality of users;
determining a relationship between the two or more users based on the information on the two or more users acquired in the acquiring; and
executing a process according to the relationship between the two or more users determined in the determining.
